(19) United States
(12) Patent Application Publication
(10) Pub. No.: US 2024/0415318 A1
(43) Pub. Date: Dec. 19, 2024

(54) MACHINE AND METHOD FOR PREPARING A BEVERAGE

(71) Applicant: DE' LONGHI APPLIANCES S.R.L. CON UNICO SOCIO, Treviso (IT)

(72) Inventors: Simone Rosetta, Treviso (IT); Guido Quaratesi, Treviso (IT); Igor Trevisan, Treviso (IT); David Luigi Petraz, Treviso (IT)

(73) Assignee: DE' LONGHI APPLIANCES S.R.L. CON UNICO SOCIO, Treviso (IT)

(21) Appl. No.: 18/703,241

(22) PCT Filed: Oct. 18, 2022
(86) PCT No.: PCT/IT2022/050280

§ 371 Date: Apr. 19, 2024

(30) Foreign Application Priority Data
Oct. 19, 2021 (IT) 102021000026822

(51) Int. Cl. A47J 31/42; A47J 31/36; A47J 31/52; A47J 31/60; A47J 42/50

(52) U.S. Cl. CPC A47J 31/42; A47J 31/3609; A47J 31/525; A47J 31/60; A47J 42/50

(57) ABSTRACT

Machine (10) for preparing a beverage starting from a dry food substance (S), preferably in grains or beans (C), comprising a hopper (15) to contain the dry food substance (S) and provided with a lower aperture (25) for the outlet of the dry food substance (S). A grinding device (16) is disposed below the lower aperture (25) to grind the dry food substance (S) and transform it into an aromatic blend (M) in powder form. A central control unit (20) is able to control the grinding device (16) and a user interface (43) is connected to the central control unit (20).

### FIELD OF THE INVENTION

The present invention concerns a machine and a method for preparing a beverage, starting from a dry food substance, preferably in grains or beans, for example coffee or barley. The machine can preferably be sized so that it can be used particularly, although not exclusively, in the domestic or semi-professional field, that is, for example, in offices or small communities.

### BACKGROUND OF THE INVENTION

In the field of machines for preparing beverages, those for producing coffee-based beverages, mainly for domestic or semi-professional use, are particularly known, in which the beverage is obtained for example by brewing an aromatic blend of coffee powder.

Machines are known which, in addition to a brewing unit, also comprise a grinding device to produce the aromatic blend in powder form in the machine itself, starting from coffee beans contained in a suitable hopper, which can be attached on the structure of the machine, or removable.

In recent years, machines with removable hoppers have become increasingly widespread, allowing consumers to easily change the variety of beans to be used, choosing them for example from Coffea Arabica, Coffea Robusta or Canephora, Coffea Liberica and Coffea Excelsa, simply by replacing the hopper, instead of manually emptying the fixed hopper and then filling it with another variety.

In general, each hopper has a lower aperture, which can be selectively closed by means of one or more closing elements and through which the coffee beans can enter the grinding device.

One example of a known machine provided with a closing element for a lower aperture which can be selectively opened and reclosed by means of a shutter portion to allow or respectively prevent the passage of the coffee beans to a grinding device is described in US-A-2020/163485.

In known machines, both when the lower aperture of the hopper is closed and also when the hopper is removed from the machine, a certain quantity of residual coffee remains inside the grinding device, both in the form of beans and also in the form of powder. Usually, this quantity of coffee is between about 5 and about 10 grams, and is sufficient to deliver another dose of a coffee-based beverage.

The presence of this residual coffee in the grinding device constitutes a considerable problem, in particular if one wishes to change the variety of coffee; in fact, in this latter case, during the preparation of the specific beverage, contamination may occur between the new variety of coffee present in the hopper and the variety of residual coffee present in the grinding device.

Furthermore, the presence of residual coffee can lead to further disadvantages, such as for example the deterioration and/or malfunction of the grinding device, thus also determining a worse quality of the coffee delivered.

To prevent these problems and/or disadvantages, it is therefore necessary to discharge or remove the residual coffee present in the grinding device.

This operation is usually performed manually, without a specific guided procedure. For example, very often it may be necessary to rotate or upend the machine itself, making the residual coffee exit and dirtying the surrounding environment. In this way, however, only a coarse removal of the residual coffee is obtained; in fact, while the beans can be removed quite easily, the correct emptying of the powdered coffee part is much more difficult to obtain.

There is therefore a need to perfect a machine and develop a method for preparing a beverage, preferably starting from a dry food substance, such as for example coffee beans, which can overcome at least one of the disadvantages of the state of the art.

In particular, one purpose of the present invention, which coincides with the technical problem to be solved, is to provide a machine and perfect a method for preparing a beverage in which the removal of any possible residual material present in the grinding device takes place automatically, without the need for any manual intervention.

Another purpose of the present invention is to provide a machine and perfect a method for preparing a beverage which allow to change the variety of the dry food substance to be used, thus preventing contamination between the previous and subsequent beverage.

Another purpose of the present invention is to provide a machine for preparing a beverage that is versatile and simple for the user to use.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, and to resolve the technical problem disclosed above in a new and original way, also achieving considerable advantages compared to the state of the prior art, a machine according to the present invention for preparing a beverage starting from a dry food substance, preferably in grains or beans, comprises: at least one hopper configured to contain the dry food substance and provided with at least one lower aperture for the outlet of the dry food substance; a grinding device disposed in correspondence with the lower aperture to grind the dry food substance and transform it into an aromatic blend in powder form; a central control unit to control at least the grinding device; and a user interface connected to the central control unit.

In accordance with one aspect of the present invention, the machine also comprises at least first detection means operatively connected to the central control unit and configured to detect the selective closure of the at least one lower aperture and send a corresponding closure signal to the central control unit so that the latter enables the user interface so that at least one option is displayed which can be selected by a user for the execution of a procedure for the automatic removal of possible residual material present in the grinding device.

In accordance with another aspect of the present invention, the central control unit, when it receives the closure signal, is configured to allow the selection on the user interface of at least a first option of removal procedure and of at least a second option different from the first option.

In accordance with another aspect of the present invention, the central control unit, when it receives the closure signal, is configured to allow the selection on the user interface of at least a first option which provides to use the residual material to prepare another dose of the beverage before discharging the residual material, and of at least a second option which provides to directly discharge the residual material without preparing any other dose of the beverage.

In accordance with another aspect of the present invention, the central control unit, when it receives the closure signal, is configured to allow the selection on the user interface also of a third option which provides to leave the residual material in the grinding device.

In accordance with another aspect of the present invention, the grinding device comprises a first chamber, disposed in proximity to or in contact with the lower aperture and configured to accommodate a certain quantity of beans, a second chamber disposed below the first chamber and in which there are grinding members to grind the beans, whereby in the second chamber both beans and also at least a part of aromatic blend in powder form can be present, and a third chamber disposed below the second chamber and configured to contain only the aromatic blend.

In accordance with another aspect of the present invention, the machine also comprises second detection means, operatively connected to the central control unit and configured to detect whether the hopper is associated with the grinding device.

In accordance with another aspect of the present invention, the user interface comprises a display device and the at least one option as above is displayed in the form of an icon which can be selected directly on the display device or in the form of a message associated with a respective button.

In accordance with another aspect of the present invention, a method is perfected for preparing a beverage starting from a dry food substance, preferably in grains or beans, by means of a machine having at least one hopper configured to contain at least the dry food substance and provided with at least one lower aperture for the outlet of the dry food substance; a grinding device disposed in correspondence with the lower aperture to grind the dry food substance and transform it into an aromatic blend in powder form; a central control unit to control at least the grinding device; and a user interface connected to the central control unit. The method also comprises a detection step in which first detection means, operatively connected to the central control unit, detect the closure of the at least one lower aperture and send a corresponding closure signal to the central control unit so that the latter enables the user interface so that it is possible to display a selection of at least one procedure for the automatic removal of possible residual material present in the grinding device.

In accordance with another aspect of the present invention, the method also comprises a selection step in which it is possible to select, by means of the user interface, at least a first option of automatic removal procedure and at least a second option different from the first option.

In accordance with another aspect of the present invention, the method also comprises a selection step in which it is possible to select, by means of the user interface, at least a first option that provides a first procedure for removing the residual material in which the latter is used to prepare another dose of the beverage and is then discharged, and at least a second option that provides a second procedure for removing the residual material in which the latter is discharged directly, without preparing any other dose of the beverage.

In accordance with another aspect of the present invention, in the selection step as above it is also possible to select, by means of the user interface, a third option that provides to keep the residual material in the grinding device.

In accordance with another aspect of the present invention, the first option of procedure for removing the residual material provides, in sequence: driving the grinding device in order to grind any beans present inside it in such a way as to obtain another dose of aromatic blend in powder form; moving the other dose of aromatic blend from the grinding device to a brewing unit; carrying out a brewing process to prepare the other dose of the beverage; and discharging the residual material.

In accordance with another aspect of the present invention, the second option of procedure for removing the residual material provides, in sequence: driving the grinding device in order to grind any beans present inside it in such a way as to obtain another dose of aromatic blend in powder form; moving the other dose of aromatic blend from the grinding device to the brewing unit; discharging the residual material, after a possible compacting of the other dose of aromatic blend, optionally humidified with water.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a schematic and simplified representation of a machine for preparing a beverage according to the present invention, in which a hopper of the machine is in an operating condition;

FIGS. 1a and 1b show the user interface of the machine for preparing beverages according to the invention, when the hopper is in a non-operating condition;

FIG. 2 is an enlarged detail of FIG. 1, in which the hopper is in a non-operating condition;

FIG. 3 is an enlarged detail of FIG. 1, in which the brewing unit is shown in a first working condition;

FIG. 4 is the enlarged detail of FIG. 3 shown in a second working condition.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

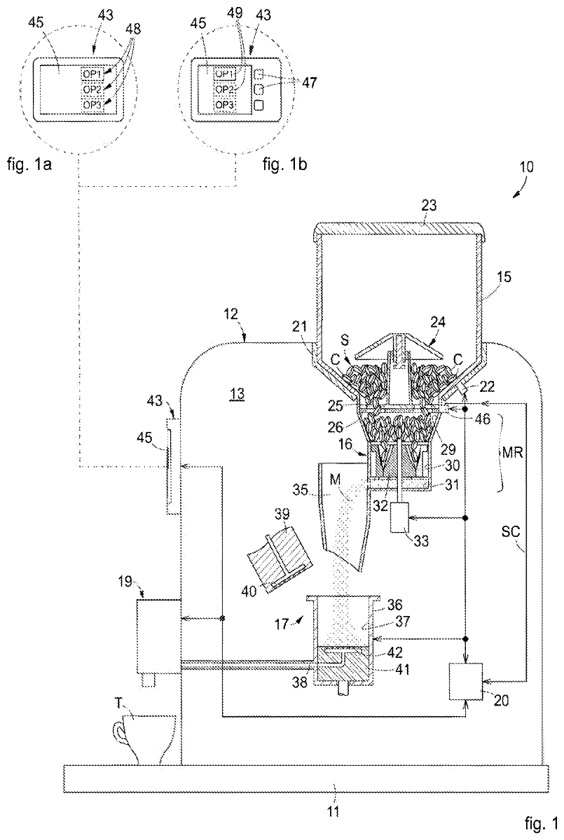

With reference to FIG. 1, a machine 10 according to the present invention can be used for preparing a beverage starting from a dry food substance S, preferably in the form of grains or beans C.

Please note that with the term “dry food substance” S, here and hereafter in the description we mean, in particular, coffee beans C or parts thereof; however, other types of food substances are not excluded, for example seeds, cereals, barley etc.

By way of example, to prepare a certain beverage with the machine 10, preferably a coffee-based beverage, initially it is necessary to perform a grinding of a certain quantity of dry food substance S, in particular coffee beans C, in order to obtain a correct dose of aromatic blend M in powder form.

The machine 10 comprises a rest plate 11 on which there is mounted a frame 12 shaped in such a way as to have an internal compartment 13 in which different operating components of the machine 10 are housed, which are intended here as a hopper 15 configured to contain the dry food substance S, in particular beans C, and a grinding device 16 disposed below the hopper 15 to grind the beans C and obtain the correct dose of aromatic blend M in powder form.

The machine 10 also comprises a brewing unit 17 configured to prepare a certain beverage, a hydraulic circuit, not shown in the drawings, to feed water to the brewing unit 17, and a delivery unit 19 fluidically connected to the brewing unit 17, which allows to deliver the certain beverage into a container T, for example a cup, a mug, or suchlike.

In addition, the machine 10 comprises a central control unit 20 of the electronic type, which is connected to the operating components of the machine 10 to command their operation.

In the example provided here, the hopper 15 is removably inserted in a respective housing compartment 21 and is coupled to the latter by means of respective coupling and/or clamping members, not shown in the drawings. A detection device 22 is associated with the housing compartment 21, connected to the central control unit 20 and configured to recognize the presence of the hopper 15 in the housing compartment 21, that is, if the hopper 15 is associated with the grinding device 16.

In accordance with other embodiments of the present invention, the hopper 15 can be of the fixed type, therefore not removable from the machine 10.

The hopper 15 substantially defines a container which has the function of containing a plurality of beans C and is provided with at least one lower aperture 25 for the outlet of the beans C toward the grinding device 16.

The hopper 15 can also comprise a closing lid 23 and a protection element 24 disposed inside it to prevent possible injuries to a user, caused by the grinding device 16.

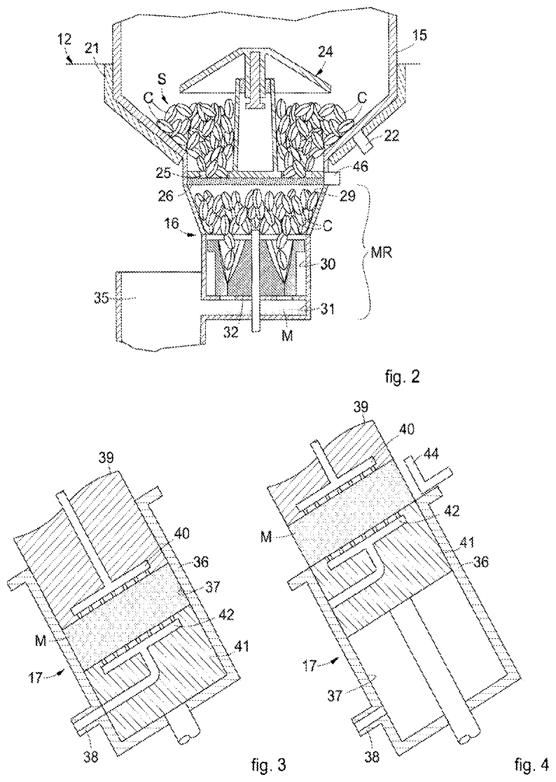

A closing element 26, of a known type and not described in detail, is operatively associated with the lower aperture 25, configured to selectively close the latter so that the hopper 15 can assume an operating condition when the lower aperture 25 is open, or a non-operating condition when the lower aperture 25 is closed (FIG. 2).

Please note that such non-operating condition can be obtained both with the closure of the lower aperture 25, and also with the removal of the hopper 15 from the housing compartment 21.

The grinding device 16 is disposed in correspondence with the lower aperture 25 and comprises at least a first chamber 29, a second chamber 30 and a third chamber 31, which are communicating with each other and disposed respectively one below the other.

The first chamber 29 is disposed in proximity to or in contact with the lower aperture 25 and is configured to accommodate a certain quantity of beans C, which pass through the lower aperture 25.

In the second chamber 30 there are one or more grinding members, for example grinders 32, which are driven selectively by a command member of a known type, such as an electric motor 33 for example, and are configured to grind the beans C coming from the first chamber 29 so as to obtain an aromatic blend M in powder form, having a certain granulometry. In the second chamber 30, therefore, both grains C as well as at least a part of aromatic blend M in powder form can be present.

The third chamber 31 is configured to contain only the aromatic blend M, and with it there is associated a conveyor duct 35 which has the function of conveying and directing the aromatic blend M toward the brewing unit 17.

We wish to clarify that it is the action of the grinders 32 that allows the movement of the aromatic blend M from the third chamber 31 to the brewing unit 17. In fact, the rotation of the grinders 32 creates a flow of air exiting from the third chamber 31 which allows to transport the aromatic blend M into the conveyor duct 35 and then toward the brewing unit 17.

The brewing unit 17 (FIGS. 1, 3 and 4) can be of any known type whatsoever, and can essentially comprise a containing body 36, open upward, which internally defines a brewing chamber 37 configured to contain a certain quantity of aromatic blend M to be subjected to brewing.

The containing body 36 is fluidically connected to a distribution duct 38 which has the function of distributing a dose of the certain beverage to the delivery unit 19.

A closing member, or piston, 39 is disposed outside the containing body 36 in a fixed position and is provided with delivery members 40 to deliver pressurized hot water into the aromatic blend M present in the brewing chamber 37.

In addition, an expulsion piston 41 is disposed sliding in the brewing chamber 37 and is provided with respective outlet members 42 which are connected to the distribution duct 38 and which allow the outlet of the certain beverage during the brewing process.

The brewing unit 17 is configured to assume at least the following two working conditions: a first working condition, schematically shown in FIG. 3, in which the containing body 36 and the expulsion piston 41 are in correspondence with the closing piston 39, so as to perform one or more compressions of the aromatic blend M to be subjected to brewing, so as to make it substantially take the form of a disc, known in the sector by the term “puck”; and a second working condition, schematically shown in FIG. 4, in which the expulsion piston 41 is stationary in the first working condition, while the containing body 36 is lowered to allow, by means of the action of a thrust member 44, the expulsion of the puck from the brewing chamber 37, discharging it in a certain discharge zone of the machine 10, not shown in the drawings.

The machine 10 also comprises a user interface 43 provided with a display device 45, for example a touchscreen, by means of which a user can select a certain beverage, set one or more characteristics thereof, or select other operating options, or modes, of the machine 10.

According to possible variants, the user interface 43 can also be provided with a traditional display device 45 and with a plurality of buttons 47 and/or knobs by means of which the user can select a certain beverage, set one or more characteristics thereof, or select other operating options, or modes, of the machine 10.

Please note that inside the grinding device 16, when the hopper 15 is in the non-operating condition (FIG. 2), there is still a certain quantity of residual material MR, that is, a certain quantity of dry food substance S, consisting of both beans C as well as aromatic blend M in powder form, which has to be advantageously removed, especially in the event that another certain beverage is to be prepared with another variety of beans.

The quantity of residual material MR can have approximately a weight comprised between about 6 g and about 12 g.

In accordance with one aspect of the present invention, in correspondence with the lower aperture 25 there is disposed at least one other detection device 46 (FIGS. 1 and 2), substantially of a known type, such as a sensor or a microswitch for example, which is operatively connected to the central control unit 20 and configured to detect the closure of the lower aperture 25 and to send a corresponding closure signal SC to the central control unit 20, so that the latter enables the user interface 43 so that it is possible to select at least one procedure for the automatic removal of the residual material MR present in the grinding device 16.

In particular, the central control unit 20 can enable the user interface 43 so that at least one option OP1, OP2 is displayed on it, which can be selected by a user to command the execution of a procedure for the automatic removal of the residual material MR.

According to some embodiments, the at least one option OP1, OP2 can for example be displayed in the form of an icon 48 which can be directly selected on the display screen 45 when this is embodied as a touchscreen (FIG. 1a).

According to possible variants, a message 49 or an image relating to the option OP1, OP2 for the automatic emptying procedure can be displayed on the display screen 45, and the selection can be made by acting on a respective button 47 and/or knob (FIG. 1b).

The automatic removal procedure can comprise at least two options, named OP1 and OP2.

In particular, the central control unit 20, when it receives the closure signal SC, is configured to allow the selection, on the user interface 43, of at least a first option OP1 which provides to use the residual material MR to prepare another dose of a certain beverage before discharging the residual material MR, and a second option OP2 which instead provides to directly discharge the residual material MR, without preparing any other dose of the beverage, as will be described in detail below.

In accordance with another aspect of the present invention, the central control unit 20 is configured to allow the selection also of a third option OP3, which provides to leave the residual material MR in the grinding device 16. For example, the third option OP3 can be selected if one only wants to fill the hopper 15 with the same type of beans C, or if one wants to remove the hopper 15 from the housing compartment 21 for maintenance.

The operation of the machine 10 described heretofore, which corresponds to the method according to the present invention, comprises the following steps.

An initial set-up step in which a machine 10 as described above is set up.

A preparation and delivery step, which provides a sequence of known operations that allow to select, prepare and deliver a certain beverage.

A detection step, in which the detection device 46 sends a closure signal SC to the central control unit 20 when it detects the closure of the lower aperture 25, so that the central control unit 20 enables the user interface 43 so that a user can select at least one procedure for the automatic removal of possible residual material MR present in the grinding device 16.

A selection step, in which it is possible to select, by means of the user interface 43, at least a first option OP1 which provides a first procedure for removing the residual material MR in which the latter is used to prepare another dose of the beverage and is then discharged, and at least a second option OP2 which provides a second procedure for removing the residual material MR in which the latter is discharged directly, without preparing any other dose of the beverage.

In particular, the beverage that can be selected during the first step of removal of the residual material MR is identified automatically on the basis of the quantity of residual material MR present in the grinding device 16. For example, the quantity of residual material MR can be measured and/or detected by means of a weighing system and/or an optical detection system of a known type, or estimated on the basis of the sizes of the chambers 29, 30, 31.

The first removal procedure initially provides to drive the grinders 32 to grind all the possible residual beans C present in the first chamber 29 and in the second chamber 30, so as to obtain another dose of aromatic blend M in powder form. Consequently, the action of the grinders 30 allows to move both the aromatic blend M already present in the third chamber 31, and also the other dose of aromatic blend M toward the brewing chamber 37 where the brewing process takes place. In this way, the entire quantity of residual material MR is transferred from the grinding device 16 to the brewing unit 17.

This brewing process is of a known type and substantially provides the compacting of the aromatic blend M through the drive of the expulsion piston 41 against the closing piston 39 (FIG. 3), and the subsequent brewing and preparation of the certain beverage by means of the delivery members 40 and the outlet members 42. Subsequently, the puck obtained from the residual material MR is discharged (FIG. 4), in a known way, into a discharge zone of the machine 10, not shown in the drawings.

The second removal procedure provides the execution of the same initial operations as the first removal procedure, but instead of carrying out the brewing and preparation of the certain beverage, once the compaction has been carried out, the delivery members 40 deliver only a small amount of water into the aromatic blend M, thus obtaining a slightly humid puck which is then discharged directly, in a known way, into a discharge zone of the machine 10, not shown in the drawings.

In accordance with one aspect of the present invention, the automatic removal procedure can also provide a third option OP3 which provides to keep the residual material M in the grinding device 16.

Therefore, if it is not necessary to discharge the residual material MR, for example if maintenance is to be carried out on the hopper 15, in the selection step as above the user can select the third option OP3, thus keeping the condition of the machine 10 unchanged.

It is clear that modifications and/or additions of parts may be made to the machine 10 and to the method as described heretofore, without departing from the field and scope of the present invention, as defined by the claims.

It is also clear that, although the present invention has been described with reference to some specific examples, a person of skill in the art shall certainly be able to achieve many other equivalent forms of machines and methods for preparing a beverage, having the characteristics as set forth in the claims and hence all coming within the field of protection defined thereby.

In the following claims, the sole purpose of the references in brackets is to facilitate their reading and they must not be considered as restrictive factors with regard to the field of protection defined by the same claims.

1. A machine (10) for preparing a beverage starting from a dry food substance (S), preferably in grains or beans (C), the machine comprising: at least one hopper (15) configured to contain said dry food substance (S) and provided with at least one lower aperture (25) for an outlet of said dry food substance (S); a grinding device (16) disposed in correspondence with said lower aperture (25) to grind said dry food substance (S) and transform it into an aromatic blend (M) in powder form; a central control unit (20) to control at least said grinding device (16); and a user interface (43) connected to said central control unit (20), said machine (10) comprising at least first detection means (46) operatively connected to said central control unit (20) and configured to detect a selective closure of said at least one lower aperture (25) and send a corresponding closure signal (SC) to said central control unit (20) such that the said central control unit (20) enables said user interface (43) such that at least one option (OP1, OP2) is displayed, which can be selected by a user for execution of a procedure for an automatic removal of possible residual material (MR) present in said grinding device (16).

2. The machine (10) as in claim 1, wherein when said central control unit (20) receives said corresponding closure signal (SC), said central control unit (20) is configured to allow a selection on said user interface (43) of at least a first option (OP1) of automatic removal procedure and of at least a second option (OP2) different from said first option (OP1).

3. The machine (10) as in claim 1, wherein when said central control unit (20) receives said corresponding closure signal (SC), said central control unit (20) is configured to allow a selection on said user interface (43) of at least a first option (OP1) that provides to use said possible residual material (MR) to prepare another dose of said beverage before discharging said residual possible material (MR), and of at least a second option (OP2) that provides to directly discharge said possible residual material (MR) without preparing any other dose of said beverage.

4. The machine (10) as in claim 2, wherein when said central control unit (20) receives said corresponding closure signal (SC), said central control unit (20) is configured to display and allow the selection on said user interface (43) also of a third option (OP3) that provides to leave said possible residual material (MR) in said grinding device (16).

5. The machine (10) as in claim 1, wherein said grinding device (16) comprises a first chamber (29), disposed in proximity of or in contact with said lower aperture (25) and configured to accommodate a certain quantity of said beans (C), a second chamber (30) disposed below said first chamber (29) and comprising grinding members (32) to grind said beans (C), whereby in said second chamber (30) both said beans (C) and also at least a part of said aromatic blend (M) in powder form can be present, and a third chamber (31) disposed below said second chamber (30) and configured to contain only said aromatic blend (M).

6. The machine (10) as in claim 1, comprising second detection means (22), operatively connected to said central control unit (20) and configured to detect whether said hopper (15) is associated with said grinding device (16).

7. The machine (10) as in claim 1, said user interface (43) comprises a display device (45) and said at least one option (OP1, OP2) is displayed in the form of an icon (48) which can be selected directly on said display device (45), or in the form of a message (49) associated with a respective button (47).

8. A method for preparing a beverage starting from a dry food substance (S), preferably in grains or beans (C), by means of a machine (10) having at least one hopper (15) configured to contain at least said dry food substance (S) and provided with at least one lower aperture (25) for an outlet of said dry food substance (S); a grinding device (16) disposed in correspondence with said lower aperture (25) to grind said dry food substance (S) and transform it into an aromatic blend (M) in powder form; a central control unit (20) to control at least said grinding device (16); and a user interface (43) connected to said central control unit (20), said method comprising detecting, by a first detection means (46), operatively connected to said central control unit (20), a closure of said at least one lower aperture (25) and sending a corresponding closure signal (SC) to said central control unit (20) to enable said user interface (43) to display at least one option (OP1, OP2) thereon, which can be selected by a user to execute a procedure for automatic removal of possible residual material (MR) present in said grinding device (16).

9. The method as in claim 8, comprising selecting, by means of said user interface (43), at least a first option (OP1) of automatic removal procedure and at least a second option (OP2) different from said first option (OP1).

10. The method as in claim 8, comprising selecting, by means of said user interface (43), at least a first option (OP1) to provide a first procedure for removing said possible residual material (MR) in which said residual material (MR) is used to prepare another dose of said beverage and is then discharged, and at least a second option (OP2) to provide a second procedure for removing said possible residual material (MR) in which said residual material (MR) is discharged directly, without preparing any other dose of said beverage.

11. The method as in claim 9, said selecting comprises selecting, by means of said user interface (43), a third option (OP3) to keep said possible residual material (MR) in said grinding device (16).

12. The method as in claim 10, said first procedure for removing said possible residual material (MR) provides, in sequence:
driving said grinding device (16) to grind any beans (C) present inside so as to obtain another dose of aromatic blend (M) in powder form; moving said other dose of aromatic blend (M) from said grinding device (16) to a brewing unit (17) of said machine (10); carrying out a brewing process to prepare said other dose of said beverage; and discharging said possible residual material (MR).

13. The method as in claim 10, said second procedure for removing said possible residual material (MR) provides, in sequence: driving said grinding device (16) in order to grind any beans (C) present inside it so as to obtain another dose of aromatic blend (M) in powder form; moving said other dose of aromatic blend (M) from said grinding device (16) to a brewing unit (17); discharging said possible residual material (MR), after compacting said other dose of aromatic blend (M), optionally humidified with water.
